(19) United States
(12) Patent Application Publication
(10) Pub. No.: US 2005/0153708 A1
(43) Pub. Date: Jul. 14, 2005

(54) Blade support structure of bulldozer

(76) Inventors: Karl R. Dommert, Chattanooga, TN (US); Jason Spitler, Chattanooga, TN (US); Masayuki Mukaino, Chattanooga, TN (US)

Correspondence Address: VARNDELL & VARNDELL, PLLC, 106-A S. COLUMBUS ST., ALEXANDRIA, VA, 22314, US

(21) Appl. No.: 10/996,461

(22) Filed: Nov. 26, 2004

Related U.S. Application Data
(63) Continuation-in-part of application No. 10/730,939, filed on Dec. 10, 2003.

(51) Int. Cl. H04Q 7/20

(52) U.S. Cl. 455/456.1

(57) ABSTRACT

In a blade support structure of a bulldozer, a rotational axis of an angle control can be formed as a rotational axis which is always directed to one vertical direction, without reference to a pitch control of a blade. A pitching joint is arranged in a front end portion of a pitch support link having a fixed length, an eccentric disc is engaged with a pitching shaft, and the eccentric disc is fitted to a fitting hole formed in a bracket arranged in a back surface of the blade. A rotational axis at a time of an angle control which is constituted by a rotational center of a universal joint rotatably supporting the blade back surface and by a rotational center of the pitching joint is formed on a vertical line with respect to the ground surface.

### TECHNICAL FIELD

The present invention relates to a blade support structure in a bulldozer in which at least a pitch angle and an angled state angle of the blade can be adjusted.

### BACKGROUND ART

As has been well known conventionally, a soil discharging plate (hereinafter, refer to a blade) is arranged in a front portion of a bulldozer, and a back surface of the blade is supported by a front portion of a blade lifting frame which can be oscillated in a vertical direction.

In recent years, for the purpose of improving a workability by the bulldozer, there has been employed a blade support structure in which a universal joint is arranged in a front portion of the blade lifting frame, and the back surface of the blade is supported by the universal joint so as to freely rotated in a three-axis direction. Accordingly, an angled state angle, a tilt angle and a pitch angle can be applied to the blade.

With regard to the angled state angle, a state in which an attitude of the blade is perpendicular to a forward moving direction of the bulldozer at a time of seeing the blade and the bulldozer from the above is called as a state in which the angled state angle is zero. Further, an angle obtained by inclining the blade at an optional angle in a clockwise direction and a counterclockwise direction around a vertical line passing through a center of the universal joint and corresponding to a rotational center, that is, an angle obtained by inclining the blade at an optional angle from the state of the angle of zero is called as the angled state angle. A state in which the angled state angle is applied to the blade is called as an angle state, and a rotational control applying the angled state angle to the blade is called as an angle control.

With regard to the tilt angle, a state in which a state of a lower end edge or an upper end edge of the blade is horizontal at a time of seeing the blade from the rear side is called as a state in which the tilt angle is zero. Further, an angle obtained by rotating the blade at an optional angle in a clockwise direction and a counterclockwise direction around an axis which passes through the rotational center of the universal joint, is arranged in a forward moving direction of the bulldozer and corresponds to a rotational axis, that is, an angle with respect to a horizontal line at a time of rotating the blade at an optional angle from the angle of zero is called as the tilt angle. A state in which the tilt angle is applied to the blade is called as a tilt state, and a rotational control applying the tilt angle to the blade is called as a tilt control.

The pitch angle means an angle of a blade edge angle of the blade with respect to the ground surface at a time of seeing the blade and the bulldozer from the side, and a rotational control applying the pitch angle to the blade in order to adjust the blade to a positive pitch or a negative pitch from a preset angular position is called as a pitch control.

In order to execute the angle control, the tilt control and the pitch control mentioned above, there have been proposed various structures for executing the pitch control in the blade support structure in the bulldozer. As the structure for executing the pitch control, there have been proposed, for example, a pitch indicating apparatus of a blade (refer to the patent document 1), a bulldozer assembly comprising angle, tilt and pitch control mechanisms (refer to the patent document 2) and the like.

The pitch indicating apparatus described in the patent document 1 is provided with a configuration shown in FIG. 6. A back surface of a blade 30 is rotatably supported in a direction of three axes comprising a rotational axis for angle control, a rotational axis for tilt control and a rotational axis for pitch control via a universal joint 31 arranged in a leading end portion of a blade lifting frame 10. The blade lifting frame 10 is arranged by a hydraulic cylinder 21 so as to freely oscillate in a vertical direction.

A bracket 65 is arranged in a back surface of an approximately intermediate portion between an upper portion and a lower portion of the blade 30, and is connected to a pair of hydraulic cylinders 22 for the angle control. It is possible to control the angled state angle of the blade 30, by expanding and contracting each of the pair of hydraulic cylinders 22.

A cylinder bracket 74 for tilting is arranged in a support column portion 11 standing from the blade lifting frame 10. The cylinder bracket 74 is connected to a hydraulic cylinder for tilt control (not shown) having one end rotatably attached to the back surface of the blade 30, in the other end. By expanding and contracting the hydraulic cylinder for the tilt control, it is possible to rotate the blade 30 around a rotational center B1 of the universal joint 31 so as to control the tilt angle of the blade 30.

A pitch support link 60 which can expand and contract in a turnbuckle manner is loaded between the support column portion 11 and an upper end portion of the blade 30. The pitch support link 60 is provided with a screw shaft 61 in which a right handed screw is formed in one end portion side and a left handed screw is formed in the other end portion side, and yokes 62 and 63 which are respectively engaged with end portion sides of the screw shaft 61. The yoke 62 and the yoke 63 can come close to each other and come apart from each other on the basis of a rotation of the screw shaft 61.

One end portion of the yoke 62 is rotatably engaged with a post 32 arranged in an upper end portion of the blade 30. Further, one end portion of the yoke 63 is rotatably engaged with a post 12 arranged in the support column portion 11.

It is possible to adjust an interval between the yoke 62 and the yoke 63 by rotating the screw shaft 61, whereby it is possible to move a rotational center P1 of the post 32 in a longitudinal direction with respect to a forward moving direction of the bulldozer. It is possible to control the pitch angle of the blade 30 by moving the rotational center P1 of the post 32 in a longitudinal direction. As a result, it is possible to execute the pitch control of the blade 30 as shown by an arrow P in the drawing.

The bulldozer assembly described in the patent document 2 has a configuration shown in FIGS. 7 and 8. FIG. 8 shows a cross sectional view taken along a line M-M in FIG. 7. In this case, the same reference numerals as those used in FIG. 6 are attached to the same constituting members as those shown in FIG. 6, and a description thereof will be omitted in the following description. Further, in the specification of the present application, the same reference numerals are attached to the same constituting members as those of the prior art.

As shown in FIG. 8, a universal joint 31 rotatably supporting a center of a back surface portion of a blade 30 is arranged in a middle stage of a support column portion 11 of a blade lifting frame 10. A bracket 33 is arranged in a center of a lower portion of the blade 30, and one end portion of a pitch support link 80 is engaged with a rotational axis borne to the bracket 33.

The other end portion of the pitch support link 80 is engaged with a pin holding bracket 82 in which a mounting position from the support column portion 11 can be adjusted by a bolt 85. The pin holding bracket 82 can be adjusted in the mounting position from the support column portion 11 on the basis of a thickness of a shim plate 83 interposed between the pin holding bracket 82 and the support column portion 11.

By interposing the shim plates 83 and 84 having different thickness H1 and H2 between the support column portion 11 and the pin holding bracket 82, it is possible to adjust a protruding amount of the pitch support link 80 to a side of the blade 30, whereby it is possible to control the pitch angle of the blade 30.

In the structures for executing the pitch control as described in patent document 1 and patent document 2, the configuration is made such that the rotational center P1 in a leading end portion of the pitch support link 60 in FIG. 6 or the pitch support link 80 in FIG. 8 is moved in the longitudinal direction with respect to the forward moving direction of the bulldozer. By moving the rotational center P1 in the longitudinal direction, it is possible to control the pitch angle of the blade 30. However, in the configuration in which the rotational center P1 is moved in the longitudinal direction in order to control the pitch angle of the blade 30, the following some problems are generated.

First, in one problem, the rotational axis PA executing the angle control of the blade 30 is formed by a line obtained by connecting a rotational center B1 of the universal joint 31 to the rotational center P1, as shown in FIGS. 6 and 8. However, in accordance with moving the rotational center P1 in the longitudinal direction in order to control the pitch angle of the blade 30, the rotational axis PA executing the angle control of the blade 30 becomes in a state of being inclined with respect to the ground surface, and it is impossible to maintain the vertical direction with respect to the ground surface.

Accordingly, in the blade 30 after the control of the pitch angle is executed, the rotational axis PA executing the angle control is inclined with respect to the ground surface, and the angle control of the blade 30 is executed by setting the inclined rotational axis PA to the rotational axis. Accordingly, it is impossible to execute the angle control of the blade 30 within a surface which is in parallel to the ground surface.

Further, in the blade 30 after the control of the pitch angle is executed, the angle control of the blade 30 can not be executed within the surface which is in parallel to the ground surface. Accordingly, if the angle control is applied to the blade 30 during the forward movement of the bulldozer, for example, at a time of executing a ground leveling work by the bulldozer, the lower line of the blade 30 becomes in a state of being in nonparallel to the ground surface. Therefore, it is necessary to correct such that the lower line of the blade 30 becomes in the state of being in parallel to the ground surface while using the tilt control together. Since the pitch control structure has a lower working performance as mentioned above, there are generated problems that a working accuracy of the ground leveling work is lowered, and the working efficiency is lowered.

These problems are generated by the change in the attitude of the rotational axis PA for executing the angle control in accordance with the pitch control. Further, in the case that a rotational center T1 (refer to FIGS. 6 and 8) of an end portion of the tilt controlling hydraulic cylinder is not arranged on the axis of the rotational axis PA, the tilt angle of the blade 30 is simultaneously changed at a time of the angle control. Accordingly, it is necessary to execute the tilt control at the same time of executing the angle control.

Patent document 1: U.S. Pat. No. 6,247,540

Patent document 2: U.S. Pat. No. 5,447,204

### DISCLOSURE OF THE INVENTION

### Problem Solved By The Invention

The present invention has been made by paying attention to the problems in the prior arts mentioned above, and an object of the present invention is to provide a blade support structure in which an attitude of a rotational axis PA for executing an angle control is not changed even if a pitch control is executed.

### Means For Solving The Problem

The object of the present invention can be achieved by each of the inventions described in claims 1 to 4 of the present invention.

In other words, in accordance with a main aspect of the present invention, as described in claim 1, there is provided a blade support structure of a bulldozer capable of adjusting at least a pitch angle and an angled state angle of a blade, comprising: a universal joint which is arranged in a front portion of a blade lifting frame and supports the blade rotatably and supports a back surface of the blade; a pitch support link in which one end thereof is rotatably supported to the blade lifting frame and an other end thereof is connected to a bracket side of the back surface of the blade; and a pitching joint which connects the other end of the pitch support link to the bracket in the back surface of the blade, wherein the pitching joint has a mechanism capable of adjusting an interval between a rotational center of the pitching joint and the blade back surface, and a rotational center of the universal joint and a rotational center of the pitching joint are always arranged on the same vertical line at a time when a tilt angle of the blade is zero degree.

Further, in accordance with a main aspect of the present invention, as described in claim 2, the pitching axis of the pitching joint is rotatably supported to an eccentric disc, and a fitting hole fitted to an outer peripheral surface of the eccentric disc is formed in the bracket of the blade back surface, as a mechanism capable of adjusting an interval between the rotational center of the pitching joint and the blade back surface.

Furthermore, in accordance with a main aspect of the present invention, as described in claims 3 and 4, the eccentric disc and the pitching shaft of the pitching joint are integrally rotatably configured or are relatively rotatably configured.

### Effect Of The Invention

In accordance with the present invention, the pitching joint is supported by the pitch support link, and the pitch control with respect to the blade is executed by adjusting the interval between the pitching joint and the back surface of the blade. Accordingly, when the tilt angle of the blade is zero degree, the rotational axis executing the angle control of the blade and connecting the rotational center of the pitching joint and the rotational center of the universal joint always exists on the same vertical line even if the pitch control is applied to the blade.

Consequently, when the angle control is executed even after the tilt control of the blade is executed, the blade can always rotate around the same vertical line, and it is possible to rotate the blade while keeping a state in which the lower line of the blade is maintained to be in parallel to the ground surface.

The mechanism for adjusting the interval between the rotational center of the pitching joint and the back surface of the blade can be formed between the pitching joint and the bracket of the blade back surface or on the bracket of the blade back surface. The adjusting mechanism can be constituted by a known interval adjusting mechanism which can adjust an interval between two points such as a turnbuckle type structure, or the combination between the eccentric disc and the bracket of the blade back surface having the fitting hole fitted to the eccentric disc as described in claim 2.

In the case of employing the mechanism for adjusting the interval between the rotational center of the pitching joint and the back surface of the blade as described in claim 2, it is possible to adjust the interval between the rotational center of the pitching joint and the back surface of the blade in the following manner.

In other words, the eccentric disc is rotated around the center of the pitching shaft of the pitching joint from a state in which the eccentric disc attached to the pitching shaft of the pitching joint is fitted to the fitting hole of the bracket on the blade back surface.

Accordingly, it is possible to change a distance in a longitudinal direction between the pitching shaft of the pitching joint and the eccentric center of the eccentric disc, that is, a distance in the longitudinal direction with respect to the forward moving direction of the bulldozer.

Further, the pitching joint can be supported by a pitch support link having a fixed length, thereby securely preventing the pitching joint from moving in the longitudinal direction. At this time, the eccentric disc moves in the longitudinal direction on the basis of the pitching shaft of the pitching joint, and the bracket of the blade back surface fitted to the eccentric disc moves in the longitudinal direction together with the blade.

Accordingly, it is possible to adjust the interval between the rotational center of the pitching joint and the blade back surface without moving the rotational center of the pitching joint in the longitudinal direction, thereby applying the pitch control to the blade.

Moreover, the rotational axis at a time of the angle control connecting the rotational center of the pitching joint to the rotational center of the universal joint rotatably supporting the blade always forms a vertical line at a time when the tilt angle of the blade is zero degree. Therefore, even if the angle control is executed after executing the pitch control, no change is generated in a tilt attitude of the blade.

The relevant configuration to the pitching shaft of the pitching joint and the eccentric disc can be made, as described in claim 3, such that the pitching shaft of the pitching joint is rotated around the axis of the pitching shaft of the pitching joint together with the eccentric disc. The configuration at this time can be made such that the pitching shaft of the pitching joint and the eccentric disc are formed in accordance with an integral molding.

Further, the configuration can be made such that the pitching shaft of the pitching joint and the eccentric disc are formed by independent bodies, the end portion of the pitching shaft of the pitching joint is formed, for example, in a hexagonal cross sectional shape, a fitting hole fitted to the end portion having the hexagonal cross sectional shape and having an inner peripheral surface formed in a hexagonal cross sectional shape is formed in the eccentric disc, and the end portion of the pitching shaft of the pitching joint is fitted to the fitting hole. Alternatively, it is possible to fix the pitching shaft of the pitching joint to the eccentric disc in accordance with a welding or the like.

Further, a relevant configuration to the pitching shaft of the pitching joint and the eccentric disc can be made, as described in claim 4, such that the eccentric disc is rotated around the pitching shaft of the pitching joint. The configuration at this time can be made such that the eccentric disc separately formed from the pitching shaft of the pitching joint is axially attached to the end portion of the pitching shaft of the pitching joint. Accordingly, it is possible to independently execute the rotation of the eccentric disc and the rotation of the pitching shaft, and the eccentric disc and the pitching shaft of the pitching joint can relatively rotate.

In any configuration, the pitch control can be applied to the blade by rotating the eccentric disc.

### BRIEF DESCRIPTION OF THE DRAWINGS

FIG. 1 is a side elevational view showing a blade support structure (embodiment);

FIG. 2 is a perspective view showing the blade support structure (embodiment);

FIG. 3 is a perspective view of a main portion of the structure for executing a pitch control in the blade support structure (embodiment);

FIG. 4 is an explanatory view at a time of executing a pitch control and an angle control of the blade (embodiment);

FIG. 5 is an explanatory view at a time of executing a pitch control and an angle control of the blade (prior (embodiment);

FIG. 6 is a perspective view showing a blade support structure (first embodiment);

FIG. 7 is a perspective view showing a blade support structure (second embodiment); and

FIG. 8 is a cross sectional view taken along a line M-M in FIG. 7 (second embodiment).

### Reference Numerals

1 bulldozer

10 blade lifting frame

11 support column portion

12 post

13 through hole

30 blade

31 universal joint

32 post

40 pitching joint

41 pitching shaft

41a first shaft portion

41b second shaft portion

42,42′ eccentric disc

42a flange portion

43 mark

44 projection

45 friction plate

48 bracket

48a,48a′ fitting hole

48b,48b′ plate portion

48c mark

50 pitch support link

51 bearing member

60 pitch support link

61 screw shaft

62,63 yoke

70 pitch support link

72 pitch joint

80 pitch support link

82 pin holding bracket

B1 rotational center

GL ground surface

PA rotational axis

P1 rotational center

S1,S2 axis

T1 rotational center

Y vertical line

### BEST MODE FOR CARRYING OUT THE INVENTION

A description will be in particular given below of a blade support structure in a bulldozer according to a preferable embodiment of the present invention with reference to the accompanying drawings. The blade support structure in accordance with the present invention is not limited to the embodiment described below, but can employ various structures as far as it is possible to adjust an interval between a pitching joint and a back surface of a blade.

Further, a relation in arrangement of a universal joint, a pitching joint and a bracket for tilt control is not limited to a relation in arrangement according to the following embodiments, but the other relation in arrangement can be employed as far as the relation in arrangement can execute the present invention.

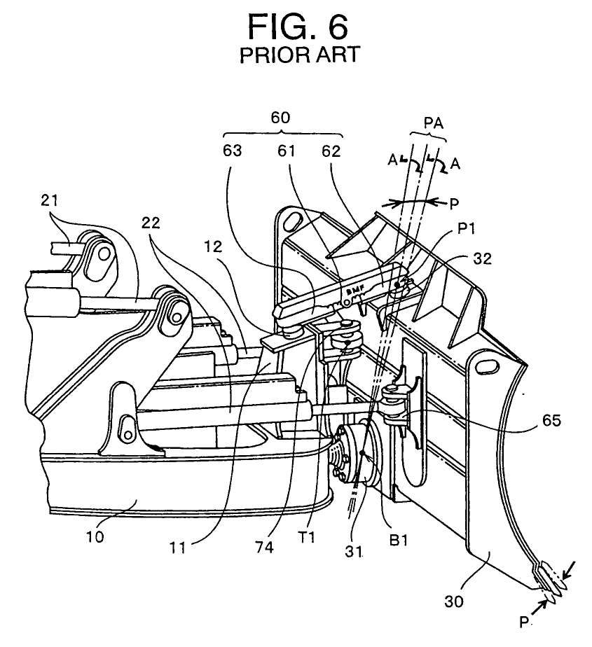

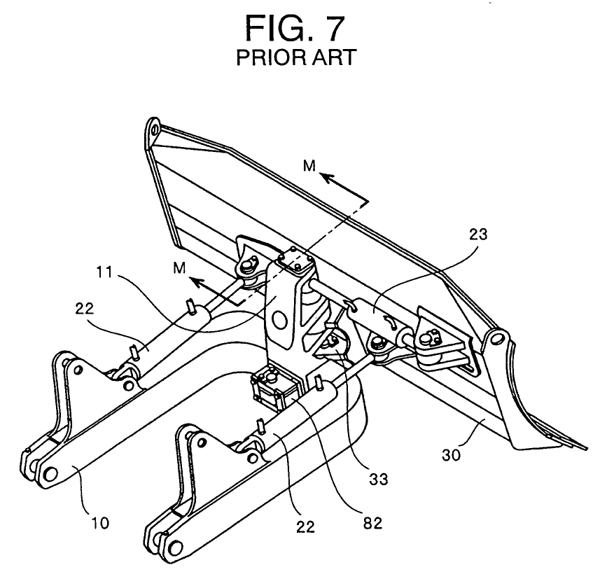

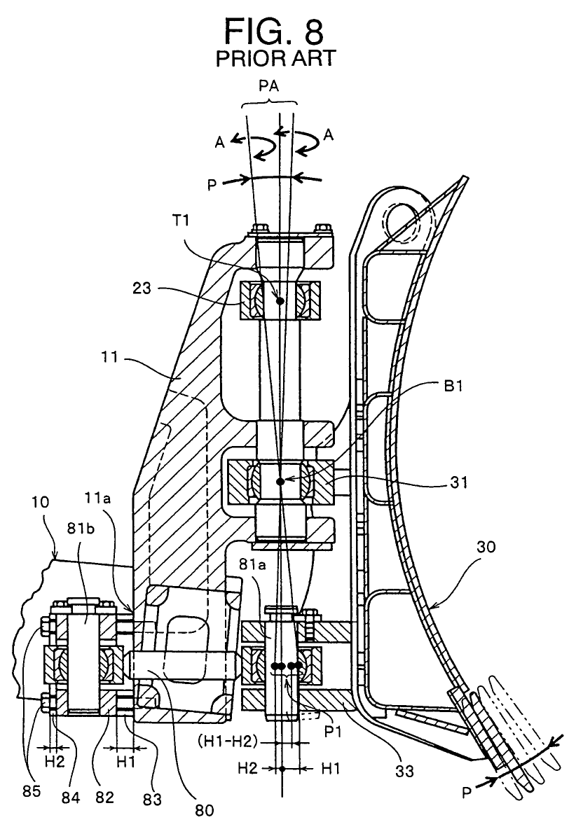

In this case, in the explanation of the embodiments in accordance with the present invention, the same reference numerals are attached to constituting members having the same functions as those of the members employed in FIGS. 6 to 8 showing the prior arts, and a description of the same members is omitted.

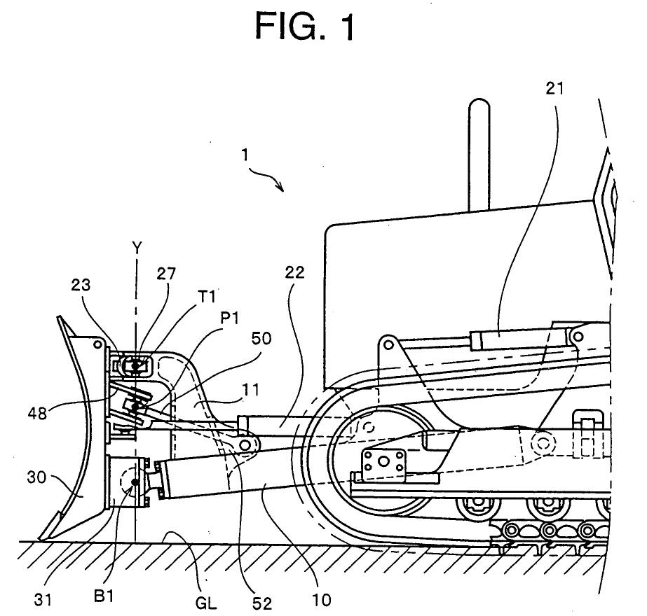

FIG. 1 is side elevational view of a bulldozer 1 having a blade support structure according to the invention. A blade lifting frame 10 is arranged in a front side of the bulldozer 1, and the blade lifting frame 10 can be oscillated and rotated in a vertical direction by a hydraulic cylinder 21.

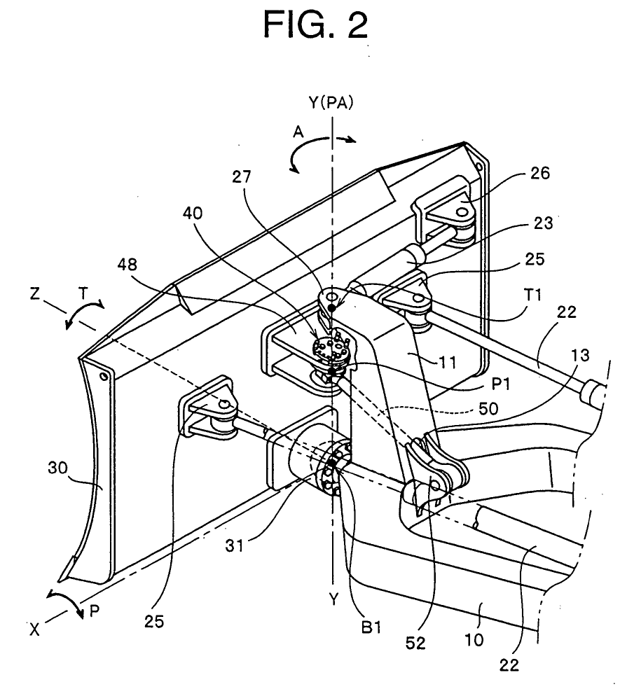

As shown in FIGS. 1 and 2, a back surface of a blade 30 is rotatably supported by a universal joint 31 arranged in a front portion of the blade lifting frame 10. A pitching joint 40 is arranged in one end portion of a pitch support link 50. The other end portion of the pitch support link 50 is loosely inserted into a through hole 13 formed in a support column portion 11 standing from the blade lifting frame 10, and is rotatably supported to a bracket 52 fixed to the support portion 11.

As shown in FIG. 2, the pitching joint 40 is connected to a bracket 48 arranged in a back surface of the blade 30. A tilt controlling hydraulic cylinder 23 applying a tilt angle to the blade 30 is configured such that one end portion is rotatably supported to a back surface side of the blade 30, and the other end portion is rotatably supported to a bracket 27 arranged in the support column portion 11.

A pair of angle controlling hydraulic cylinders 22 applying an angled state angle to the blade 30 is configured such that each of one end portions is rotatably supported to the blade lifting frame 10, and the other end portions are rotatably supported to a pair of brackets 25 arranged in the back surface of the blade 30.

When the tilt angle of the blade 30 is zero degree, a rotational center B1 of the universal joint 31, a rotational center P1 of the pitching joint 40 and a rotational center T1 of the bracket 27 are arranged on one vertical line Y.

By alternately expanding and contracting the pair of angle controlling hydraulic cylinders 22, it is possible to rotate the blade 30 around a rotational center line constituted by a rotational axis PA connecting the rotational center B1 of the universal joint 31 and the rotational center P1 of the pitching joint 40 in a direction of an arrow A in FIG. 2. Accordingly, it is possible to execute the angle control of the blade 30.

By expanding and contracting the tilt controlling hydraulic cylinder 23, it is possible to rotate the blade 30 around a rotational center line constituted by an axis Z passing through the rotational center B1 of the universal joint 31 and being orthogonal to the vertical line Y in a direction of an arrow T in FIG. 2. Accordingly, it is possible to execute the tilt control of the blade 30.

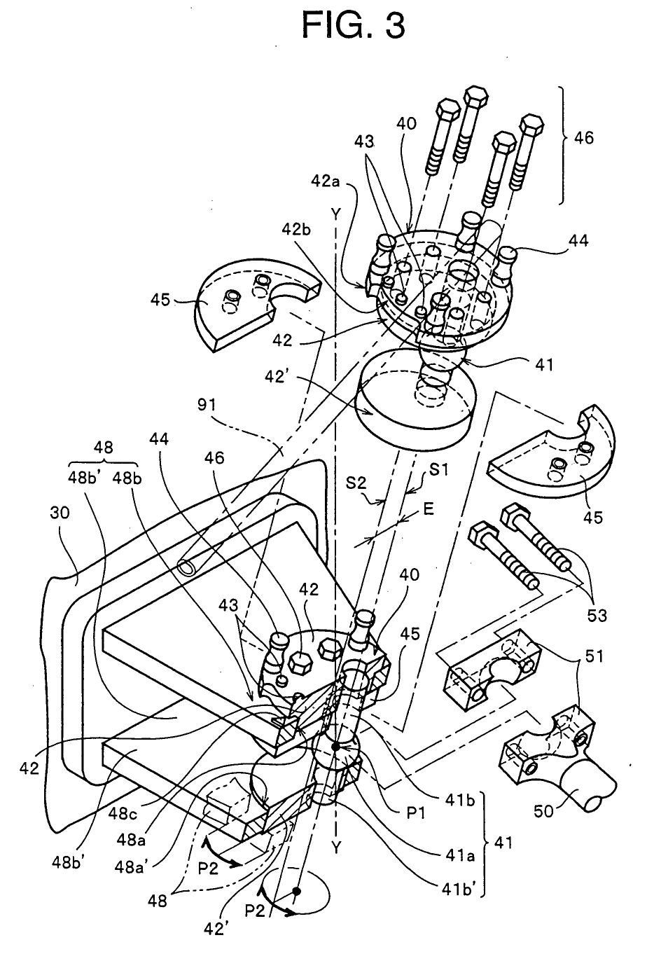

A pitch control of the blade 30 can be executed by adjusting an interval between the pitching joint 40 and the back surface of the blade 30. In other words, it is possible to rotate the blade 30 in a direction of an arrow P in FIG. 2, by adjusting an interval between the pitching joint 40 and the back surface of the blade 30, around a rotational center line constituted by an axis X passing through the rotational center B1 of the universal joint 31 and being orthogonal to the axis Z. A description will be given of a pitch control of the blade 30 with reference to FIG. 3.

FIG. 3 shows both of a state before assembling a friction plate 45 for fixing a pair of eccentric discs 42 and 42′, a pitching shaft 41 and an eccentric disc 42 to a blade 48, and a state in which the friction plate 45 is assembled and attached to a blade 48b, in order to easily understand a configuration of controlling the pitch of the blade 30.

The axis X, the vertical line Y (the rotational axis PA) and the axis Z form three axes which are orthogonal at an intersecting point constituted by the rotational center B1 of the universal joint 31. The rotational axis PA at a time of executing the angle control of the blade 30 coincides with the vertical line Y at a time when the tilt angle of the blade 30 is zero degree. When the tilt control is applied to the blade 30, the rotational axis PA rotates in a direction of an arrow T in FIG. 2 around a rotational center line constituted by the axis Z, and is inclined on one plane including the vertical line Y.

Further, the pitch control of the blade 30 can be executed by adjusting the interval between the pitching joint 40 and the back surface of the blade 30. Accordingly, the rotational center P1 of the pitching joint 40 always exists on the vertical line Y without reference to the pitch angle of the blade 30 if the tilt control is not executed.

In other words, if the tilt control is not executed, the blade 30 can always rotate around the rotational center line constituted by the vertical line Y in the angle control, even after the pitch control is applied to the blade 30.

A description will be given of a configuration of executing the pitch control with reference to FIG. 3. The pitching shaft 41 of the pitching joint 40 is constituted by a first spherical shaft portion 41a and second columnar shaft portions 41b and 41b′ extending from both ends of the first shaft portion 41a. The first shaft portion 41a is engaged with a two-piece type bearing member 51 attached to a leading end of the pitch support link 50.

An inner peripheral surface of the two-piece type bearing member 51 is formed in a shape complementing the spherical shape of the first shaft portion 41a, and rotatably supports the first shaft portion 41a. The two-piece type bearing member 51 can be integrally fixed by a bolt 53.

An axis S1 of the second shaft portions 41b and 41b′ and an axis S2 of the eccentric discs 42 and 42′ are axially attached to the second shaft portions 41b and 41b′ in a state of being spaced at an interval E, respectively. The eccentric discs 42 and 42′ are fitted to fitting holes 48a and 48a′ formed in plate portions 48b and 48b′ of the bracket 48, respectively.

The bracket 48 is arranged in the back surface of the blade 30. A flange portion 42a is formed in one eccentric disc 42 in the pair of eccentric discs 42 and 42′, and a notch portion 42b is formed in a part of the flange portion 42a.

The eccentric disc 42 can be fixed to the plate portion 48b by fitting the eccentric disc 42 to the fitting hole 48a formed in the plate portion 48b, mounting the flange portion 42a to an upper surface side of the plate portion 48b, thereafter arranging the separated friction plate 45 in a lower surface side of the plate portion 48b and fastening the flange portion 42a and the friction plate 45 by a bolt 46.

The eccentric disc 42′ arranged in a lower side in FIG. 3 of the pair of eccentric discs 42 and 42′ can be fitted to the stepped fitting hole 48a′ formed in the plate portion 48b′ arranged in the lower side of the bracket 48. Alternatively, a flange portion which can be mounted on the plate portion 48b′ can be formed in the lower side eccentric disc 42′.

In the configuration mentioned above, the description is given of the embodiment in which the pair of eccentric discs 42 and 42′ and the pitching shaft 41 are configured so as to be relatively rotatable. However, the configuration may be made such that the pair of eccentric discs 42 and 42′ and the pitching shaft 41 integrally rotate. In this case, the configuration can be made such that the pair of eccentric discs 42 and 42′ and the pitching shaft 41 integrally rotate, in any case that the pair of eccentric discs 42 and 42′ and the pitching shaft 41 are integrally formed, or the fitting shape in the fitting portion between the second shaft portion 41b and the eccentric disc is formed in a polygonal shape or the like.

Further, in any case that the pair of eccentric discs 42 and 42′ and the pitching shaft 41 are connected in accordance with the welding, or the pair of eccentric discs 42 and 42′ and a part or an entire of the pitching shaft 41 are formed in accordance with a casting or a forging, the configuration can be made such that the pair of eccentric discs 42 and 42′ and the pitching shaft 41 integrally rotate.

A plurality of marks 43 are formed in a peripheral edge of the notch portion 42b of the eccentric disc 42, and it is possible to adjust an amount of rotation of the eccentric disc 42 around the axis S1 of the second shaft portion 41b, by aligning a mark 48c formed on the plate portion 48b with the mark 43.

At this time, since the pitching shaft 41 having the second shaft portion 41b is supported and constrained by the bearing member 51 fixed to the pitch support link 50, a position of the axis S1 of the second shaft portion 41b is not moved.

A plurality of projections 44 are fixed to the eccentric disc 42, and it is possible to rotate the eccentric disc 42 around the axis S1 of the second shaft portion 41b by bringing a rotating tool such as a pipe member 91 or the like shown by a two-dot chain line in FIG. 3 into contact with the projection 44 and applying a rotational torque to the eccentric disc 42. An amount of rotation obtained by rotating the eccentric disc 42 can be adjusted on the basis of the alignment between the mark 48c and the mark 43.

When rotating the eccentric disc 42, the fastening state to the friction plate 45 is cancelled by loosening the bolt 46 mentioned above. After rotating the eccentric disc 42, the eccentric disc 42 is fixed to the plate portion 48b by the flange portion 42a of the eccentric disc 42 and the friction plate 45 by fastening the bolt 46.

The eccentric disc 42′ can be also rotated around the rotational center constituted by the axis S1 of the second shaft portion 41b′ by using a projection and a mark which rotate the eccentric disc 42′ and are not illustrated, in the same manner as the eccentric disc 42.

In the case that the configuration is made so as to integrally rotate the pair of eccentric discs 42 and 42′ and the pitching shaft 41, it is possible to integrally rotate the eccentric disc 42′ on the basis of the rotation of the eccentric disc 42.

Since the pair of eccentric discs 42 and 42′ are rotated around the axis S1 of the second shaft portion 41b, the eccentric discs 42 and 42′ are moved in the longitudinal direction as shown by an arrow P2 in FIG. 3. Accordingly, the bracket 48 is moved forward and backward as shown by the arrow P2 in FIG. 3 via the fitting holes 48a and 48a′ respectively fitted to the eccentric discs 42 and 42′. This makes it possible to execute the pitch control of the blade 30 as shown by an arrow P in FIG. 2.

On the basis of the configuration mentioned above in the pitching joint 40, the pitch control of the blade 30 can be executed in a state in which the rotational center P1 of the pitch joint 40 arranged in the front end portion of the pitch support link 50 is maintained on the vertical line Y mentioned above. Accordingly, it is possible to apply the angle control to the blade 30 around the vertical line Y without reference to the pitch control state with respect to the blade 30.

In the case that the pitch control is applied to the blade 30, the plate portions 48b and 48b′ of the bracket 48 are moved along a circular arc locus shown by the arrow P2 in FIG. 3 strictly seen, and the circular arc locus does not necessarily coincide with a circular arc around the X axis shown in FIG. 2. Therefore, the rotational center P1 of the pitch joint 40 generates a slight displacement from the vertical axis Y. However, since an amount of displacement is not great, in fact, there is no problem even if the rotational center P1 of the pitch joint 40 is considered to be maintained on the vertical axis Y as mentioned above.

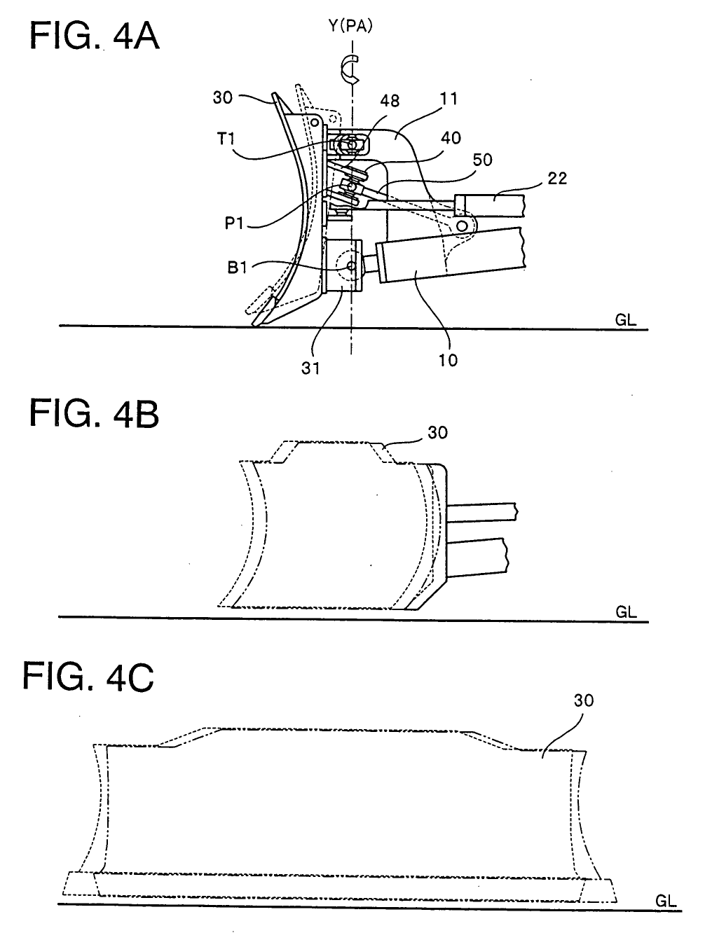

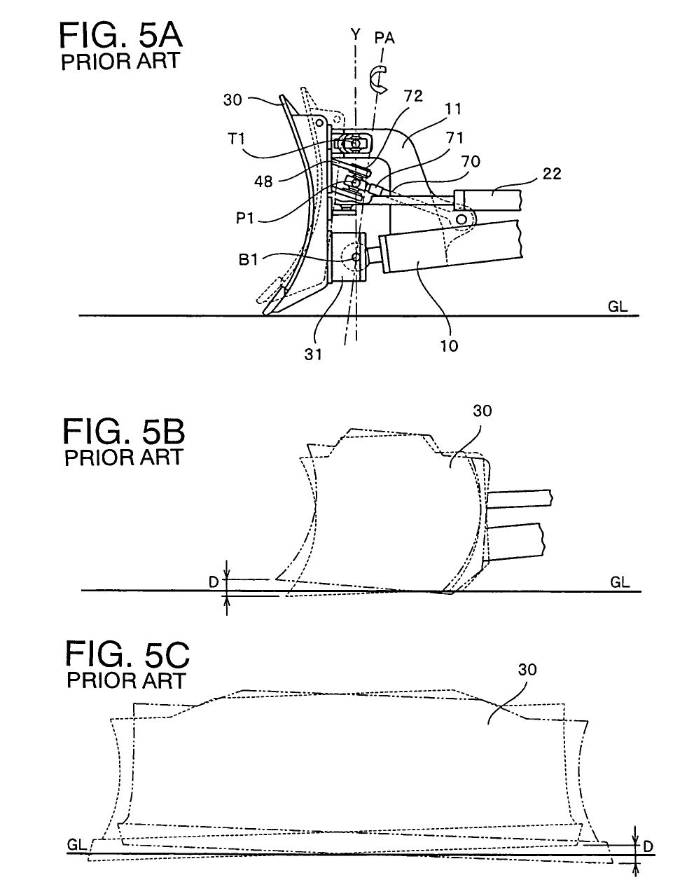

Consequently, the angle control of the blade 30 can be executed while maintaining a state in which the lower end edge of the blade 30 is in parallel to the ground surface. A description is further given of this matter with reference to FIGS. 4 and 5.

FIG. 4 is an explanatory view of a case that the angle control is executed after the pitch control is executed by using the blade support structure having the configuration according to the invention. FIG. 5 is an explanatory view of a case that the angle control is executed after the pitch control is executed by using the blade support structure for executing the pitch control by adjusting the length of the pitch support link 70 as in the prior art. In this case, both FIGS. 4 and 5 are explanatory views in a state in which the tilt control is not applied to the blade 30.

FIG. 4A shows a state in which the pitch control is applied to the blade 30 by rotating the eccentric disc mentioned above. A state shown by a solid line expresses a state before the pitch control is executed, and a state shown by a dotted line expresses a state in which the blade 30 is pitch controlled to the rear side. As mentioned above, even if the pitch control is executed on the basis of the blade support structure according to the invention, the rotational axis PA at a time of the angle control connecting the rotational center B1 of the universal joint 31 and the rotational center P1 of the pitching joint 40 does not deflect from the vertical line Y.

FIG. 5A shows a state in which the pitch control is applied to the blade 30 by rotating a turnbuckle 71 arranged in the pitch support link 70. A state shown by a solid line expresses a state before the pitch control is executed, and a state shown by a dotted line expresses a state in which the blade 30 is pitch controlled to the rear side. The length of the pitch support link 70 is shortened by contracting the turnbuckle 71, and a pitch joint 72 is moved to the rear side. Accordingly, the rotational axis PA at a time of the angle control connecting the rotational center B1 of the universal joint 31 and the rotational center P1 of the pitching joint 40 is in a state of being deflected from the vertical line Y so as to be inclined to the rear side.

FIG. 4B shows a diagonal side elevational view of the blade 30 at a time when the angle control is next applied to the blade 30 to which the pitch control is applied as shown by the dotted line in FIG. 4A, and FIG. 4C shows a front elevational view of the blade 30. In the same manner, FIG. 5B shows a diagonal side elevational view of the blade 30 at a time when the angle control is next applied to the blade 30 to which the pitch control is applied as shown by the dotted line in FIG. 5A, and FIG. 5C shows a front elevational view of the blade 30.

States shown by dotted lines and states shown by two-dot chain lines in FIGS. 4B and 4C and FIGS. 5B and 5C respectively show states in which the blade is rotated at different angles of angle from the state shown by dotted lines in which the pitch controls shown in FIGS. 4A and 5A are executed. As shown in FIGS. 4B and 4C, even if the blade 30 is set in the different angle states by executing the angle control, the lower end edge of the blade 30 can maintain the state which is in parallel to the ground surface.

On the contrary, as shown in FIGS. 5B and 5C, the lower end edge of the blade 30 is in a state which is inclined to the ground surface from the state in which the pitch control is executed, and one end portion of the lower end edge of the blade is moved upward and downward within a range of a distance D by executing the angle control from this state.

Accordingly, it is necessary to execute the tilt control such that the lower end edge of the blade 30 becomes in parallel to the ground surface GL after the angle control is executed. Further, it is necessary to execute the tilt control every time when the angled state angle of the blade 30 is changed, whereby the lower end edge of the blade 30 becomes in the state which is in parallel to the ground surface GL.

As mentioned above, in accordance with the present invention, it is possible to apply the angle control to the blade 30 within a surface which is in parallel to the ground surface, while maintaining the state in which the lower end edge of the blade 30 is in parallel to the ground surface, regardless of the pitch control state of the blade 30. Therefore, it is possible to achieve an improved working accuracy in the ground leveling work, and a high working performance.

In this case, the description mentioned above is given of the configuration in which the eccentric disc is manually rotated and the eccentric disc rotated by using the friction plate is fixed to the bracket. However, the present invention is not limited to the configuration mentioned above, but may be configured such that the eccentric disc is rotated and fixed by using driving means, for example, an adjusting screw, a hydraulic cylinder or the like.

Further, as mentioned above, in the present embodiment, the rotational center T1 of the bracket 27 rotatably supporting one end portion of the tilt controlling cylinder 23 is also arranged on the vertical line Y as shown in FIG. 1. Accordingly, the position of the rotational center T1 is not moved at a time of the angle control, and the tilt angle of the blade 30 is not changed at a time of the angle control.

### Industrial Applicability

In the structure which executes the rotational control on the basis of the rotation around at least two axes, in the apparatus in which it is necessary that the rotational axis around the other axis is not moved for the rotation around one axis, the present invention can be applied.

1. A blade support structure of a bulldozer capable of adjusting at least a pitch angle and an angled state angle of a blade, comprising:
a universal joint which is arranged in a front portion of a blade lifting frame and supports the blade rotatably and supports a back surface of the blade;
a pitch support link in which one end thereof is rotatably supported to the blade lifting frame and an other end thereof is connected to a bracket side of the back surface of the blade; and
a pitching joint which connects the other end of the pitch support link to the bracket in the back surface of the blade,
wherein the pitching joint has a mechanism capable of adjusting an interval between a rotational center of the pitching joint and the back surface of the blade, and
a rotational center of the universal joint and a rotational center of the pitching joint are always arranged on a same vertical line at a time when a tilt angle of the blade is zero degree.

2. The blade support structure according to claim 1, wherein, as the mechanism capable of adjusting an interval between the rotational center of the pitching joint and the back surface of the blade, a pitching axis of the pitching joint is rotatably supported to an eccentric disc, and a fitting hole fitted to an outer peripheral surface of the eccentric disc is formed in the bracket of the blade back surface.

3. The blade support structure according to claim 1, an eccentric disc fitted to the bracket in the back surface of the blade and a pitching shaft of the pitching joint are integrally molded, and an eccentric disc and the pitching shaft of the pitching joint are integrally rotatable with respect to the bracket in the back surface of the blade.

4. The blade support structure according to claim 1, a pitching shaft of the pitching joint is rotatably supported to an eccentric disc fitted to the bracket in the back surface of the blade, and the eccentric disc and the pitching shaft of the pitching joint are relatively rotatable.
